(19) United States
(12) Patent Application Publication
(10) Pub. No.: US 2023/0236609 A1
(43) Pub. Date: Jul. 27, 2023

(54) MOBILE OBJECT MANAGEMENT DEVICE, MOBILE OBJECT MANAGEMENT METHOD, AND STORAGE MEDIUM

(71) Applicant: HONDA MOTOR CO., LTD., Tokyo (JP)

(72) Inventors: Shinichiro Kobashi, Wako-shi (JP); Sachiko Yamamoto, Wako-shi (JP); Takeshi Echizenya, Wako-shi (JP); Misato Echizenya, Tokyo (JP)

(21) Appl. No.: 18/086,769

(22) Filed: Dec. 22, 2022

(30) Foreign Application Priority Data
Jan. 26, 2022 (JP) 2022-009875

(51) Int. Cl. G05D 1/02; G06Q 50/30

(52) U.S. Cl. CPC G05D 1/0297; G06Q 50/30; G05D 2201/0212

(57) ABSTRACT

According to an embodiment, a mobile object management device for managing a ridable mobile object that a user is allowed to get on and which moves inside of a prescribed area includes an acquirer configured to acquire location information of the ridable mobile object, a manager configured to manage the ridable mobile object and a terminal device of the user on the ridable mobile object in association with each other, and an event operation instructor configured to cause the ridable mobile object to execute a prescribed operation corresponding to an event via the terminal device of the user on the basis of the location information and information about the event that is executed inside of the prescribed area. The manager manages whether or not to permit participation in the event of the user on the basis of a state in which the user uses the ridable mobile object.

### CROSS-REFERENCE TO RELATED APPLICATION

Priority is claimed on Japanese Patent Application No. 2022-009875, filed Jan. 26, 2022, the content of which is incorporated herein by reference.

### BACKGROUND

### Field of the Invention

The present invention relates to a mobile object management device, a mobile object management method, and a storage medium.

### Description of Related Art

In the related art, technology for remotely controlling lights provided on mobile objects and light emitters owned by spectators watching a parade of the mobile objects by an instruction controller when the parade is held at an amusement park or the like is known (for example, Japanese Unexamined Patent Application, First Publication No. 2004-39415).

### SUMMARY

However, in the related art, a mechanism for not only watching an event such as a parade, but also participating in the event is not taken into account. Thus, there is a possibility that a performance effect of the event is not sufficient and is not sufficiently achieved.

An aspect of the present invention has been made in consideration of such circumstances and an objective thereof is to provide a mobile object management device, a mobile object management method, and a storage medium capable of further improving a performance effect of an event.

A mobile object management device, a mobile object management method, and a storage medium according to the present invention adopt the following configurations.

(1): According to an aspect of the present invention, there is provided a mobile object management device for managing a ridable mobile object that a user is allowed to get on and which moves inside of a prescribed area, the mobile object management device including: an acquirer configured to acquire location information of the ridable mobile object; a manager configured to manage the ridable mobile object and a terminal device of the user on the ridable mobile object in association with each other; and an event operation instructor configured to cause the ridable mobile object to execute a prescribed operation corresponding to an event via the terminal device of the user on the basis of the location information and information about the event that is executed inside of the prescribed area, wherein the manager manages whether or not to permit participation in the event of the user on the basis of a state in which the user uses the ridable mobile object.

(2): In the above-described aspect (1), the manager decides on an event in which the user is able to participate on the basis of information including at least one of the number of uses and usage time of the ridable mobile object of the user.

(3): In the above-described aspect (1), the manager sets a possible participation level of the user for the event on the basis of a state in which the user uses the ridable mobile object and manages an operation capable of being executed by the ridable mobile object of the user in accordance with the set possible participation level.

(4): In the above-described aspect (3), the manager manages a performance operation of the event in which the user is able to participate on the basis of the possible participation level.

(5): In the above-described aspect (3), the manager acquires an event in which the user is able to participate on the basis of the possible participation level and notifies the user of information for asking the user about whether or not to participate in the acquired event.

(6): In the above-described aspect (1), the manager restricts participation in an event in which the user was able to participate in the past on the basis of at least one of elapsed time after the user previously participated in the event and elapsed time after the user previously rode the ridable mobile object.

(7): In the above-described aspect (1), the manager transmits information for giving a lecture about an operation of the ridable mobile object to the user before the user participates in the event to a terminal device of the user.

(8): In the above-described aspect (1), the manager provides the ridable mobile object to the user or gives incentives to a service provider that plans the event on the basis of the state in which the user uses the ridable mobile object.

(9): In the above-described aspect (1), the event operation instructor adjusts content of the prescribed operation on the basis of information about the user on the ridable mobile object or a surrounding environment of the ridable mobile object.

(10): In the above-described aspect (1), the event operation instructor adjusts content of the prescribed operation on the basis of setting content from the user on the ridable mobile object.

(11): According to an aspect of the present invention, there is provided a mobile object management method including: acquiring, by a computer of a mobile object management device for managing a ridable mobile object that a user is allowed to get on and which moves inside of a prescribed area, location information of the ridable mobile object; managing, by the computer, the ridable mobile object and a terminal device of the user on the ridable mobile object in association with each other; causing, by the computer, the ridable mobile object to execute a prescribed operation corresponding to an event via the terminal device of the user on the basis of the location information and information about the event that is executed inside of the prescribed area; and managing, by the computer, whether or not to permit participation in the event of the user on the basis of a state in which the user uses the ridable mobile object.

(12): According to an aspect of the present invention, there is provided a computer-readable non-transitory storage medium storing a program for causing a computer of a mobile object management device for managing a ridable mobile object that user is allowed to get on and which moves inside of a prescribed area to: acquire location information of the ridable mobile object; manage the ridable mobile object and a terminal device of the user on the ridable mobile object in association with each other; cause the ridable mobile object to execute a prescribed operation corresponding to an event via the terminal device of the user on the basis of the location information and information about the event that is executed inside of the prescribed area; and manage whether or not to permit participation in the event of the user on the basis of a state in which the user uses the ridable mobile object.

According to the above-described aspects (1) to (12), it is possible to further improve a performance effect of an event.

### BRIEF DESCRIPTION OF THE DRAWINGS

FIG. 1 is a configuration diagram of a mobile object management system according to an embodiment.

FIG. 2 is a diagram for describing content of user information.

FIG. 3 is a diagram for describing content of event information.

FIG. 4 is a diagram showing an example of a functional configuration of a manager.

FIG. 5 is a diagram showing an example of content of usage history information.

FIG. 6 is a diagram for describing content of operation information.

FIG. 7 is a configuration diagram of a terminal device according to the embodiment.

FIG. 8 is a perspective view showing the appearance of a ridable mobile object of the embodiment.

FIG. 9 is a perspective view of an omnidirectional moving wheel.

FIG. 10 is a diagram for describing details of an operation of the omnidirectional moving wheel of the ridable mobile object.

FIG. 11 is a configuration diagram showing an example of a ridable mobile object according to the embodiment.

FIG. 12 is a sequence diagram showing an example of a process executed by the mobile object management system.

FIG. 13 is a diagram showing an example of an image displayed on a display of the terminal device.

FIG. 14 is a diagram showing an example of an image for asking a user about specific participation content.

FIG. 15 is a diagram showing an example of an image for asking a user U about a performance operation.

FIG. 16 is a diagram showing a specific example of mobile object management for the ridable mobile object.

FIG. 17 is a diagram showing an example of an image provided to a user who has participated in an event.

FIG. 18 is a diagram for describing a state in which a lecture about a performance operation is given to the user U who is scheduled to participate in an event.

### DESCRIPTION OF EMBODIMENTS

Hereinafter, embodiments of a mobile object management device, a mobile object management method, and a storage medium of the present invention will be described with reference to the drawings. In the following description, a mobile object management system including a ridable mobile object that moves within a prescribed area where a user is allowed to get thereon and a mobile object management server that manages the ridable mobile object will be described. The prescribed area is, for example, an area of a facility having a prescribed size such as a theme park, leisure land, an amusement park, a zoo, an aquarium, or a shopping mall. The prescribed area may be an area within a range designated by location information such as latitude and longitude.

### [System Configuration]

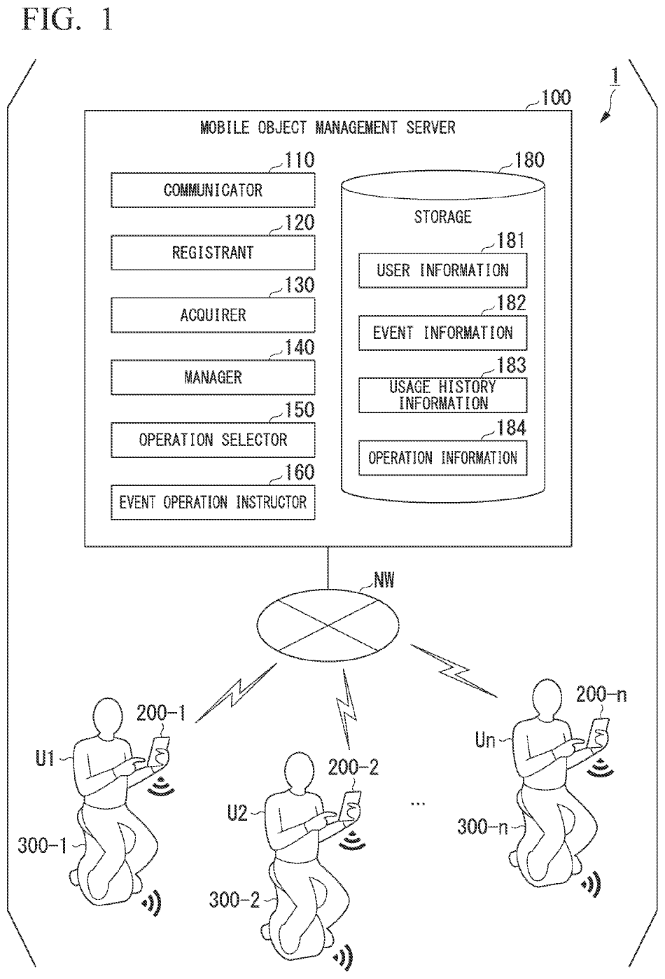

FIG. 1 is a configuration diagram of a mobile object management system 1 according to an embodiment. The mobile object management system 1 includes, for example, a mobile object management server 100, terminal devices 200-1 to 200-n of a plurality of users U1 to Un (n is 2 or more), and ridable mobile object 300-1 to 300-n that the users U1 to Un get on. Hereinafter, unless the users U1 to Un are separately described, they will be simply referred to as and described as a “user U.” Likewise, the terminal devices 200-1 to 200-n will be referred to as and described as a “terminal device 200” and the ridable mobile objects 300-1 to 300-n will be referred to as and described as a “ridable mobile object 300.” For example, the mobile object management server 100 and the terminal device 200 can communicate with each other via a network NW. The network NW includes, for example, the Internet, a wide area network (WAN), a local area network (LAN), a telephone circuit, a public circuit, a dedicated circuit, a provider device, a radio base station, and the like. The mobile object management server 100 is an example of a “mobile object management device.” The terminal device 200 and the ridable mobile object 300 can communicate with each other on the basis of, for example, Wi-Fi (registered trademark), Bluetooth (registered trademark), and other communication standards for near-field wireless communication. The ridable mobile object 300 may be able to communicate with the mobile object management server 100 via the network NW.

The mobile object management server 100 manages the user U using the ridable mobile object 300 and controls an operation of the ridable mobile object 300. The mobile object management server 100 manages the ridable mobile object 300 and the terminal device 200 of the user U in association with each other. The terminal device 200 is, for example, a portable terminal with which the user U can get on the ridable mobile object 300 and is specifically a smartphone or a tablet terminal. The terminal device 200 may be a wearable terminal worn by the user U. The terminal device 200 is a terminal device owned by user U. The ridable mobile object 300 is a mobile object that moves within a prescribed area with the user U that is allowed to get thereon. The ridable mobile object 300 is, for example, a device provided (rented) from the service provider side in the mobile object management system 1 for the user U to move within the prescribed area. For example, the ridable mobile object 300 is a vehicle, micromobility, a robot, or the like that can move while the user U is sitting on a seat of the ridable mobile object 300 or standing on steps. The ridable mobile object 300 moves within a prescribed area or executes a prescribed operation in a state in which the user U is allowed to get thereon on the basis of an operation instruction based on a manipulation by the user U or an operation instruction from the mobile object management server 100. The prescribed operation includes, for example, an operation (e.g., movement, rotation, or the like) in accordance with music output in association with the execution of an event executed in the prescribed area or an operation of a physical object associated with the event. The prescribed operation may include an operation of outputting a sound from an audio output provided in the ridable mobile object 300 and an operation of causing a light emitter provided in the ridable mobile object 300 to emit light. The ridable mobile object 300 may guide the user U so that a prescribed operation is executed according to a manipulation of the user U or output information (for example, a voice) for prompting the user U to perform a manipulation, and may perform the prescribed operation regardless of the manipulation of the user U. Events include, for example, a parade that marches along a prescribed route within a prescribed area at a prescribed time or a show (for example, an event such as a play or concert) that is held at a specific place within a prescribed area at a prescribed time. The event may include, for example, an event (a group event) generated by the gathering of a prescribed number of ridable mobile objects 300 within a specific range within a prescribed area. Physical objects related to the event include, for example, people participating in the event (mascot characters, musical instrument performers, dancers, various types of cast members such as puppets), mobile objects (parade cars and drones), and the like. For example, the user U can use the ridable mobile object 300 within a prescribed area by performing a registration process or the like on the mobile object management server 100 via the terminal device 200. Hereinafter, details of the mobile object management server 100, the terminal device 200, and the ridable mobile object 300 will be described. Hereinafter, the prescribed area will be described as a theme park.

### [Mobile Object Management Server]

The mobile object management server 100 shown in FIG. 1 includes, for example, a communicator 110, a registrant 120, an acquirer 130, a manager 140, an operation selector 150, an event operation instructor 160, and a storage 180. The registrant 120, the acquirer 130, the manager 140, the operation selector 150, and the event operation instructor 160 are implemented, for example, by a hardware processor such as a central processing unit (CPU) executing a program (software). Some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as a hard disk drive (HDD) or a flash memory or may be stored in a removable storage medium (a non-transitory storage medium) such as a DVD or a CD-ROM and installed in the storage device of the mobile object management server 100 when the storage medium is mounted in a drive device or the like. For example, the mobile object management server 100 may function as a cloud server that communicates with the terminal device 200 via the network NW and transmits and receives various types of data.

The storage 180 may be implemented by the various types of storage devices described above, a solid-state drive (SSD), an electrically erasable programmable read-only memory (EEPROM), a read-only memory (ROM), a random-access memory (RAM), or the like. For example, user information 181, event information 182, usage history information 183, operation information 184, programs, and various types of other information are stored in the storage 180. The storage 180 may store map information of the theme park. Details of the user information 181, the event information 182, the usage history information 183, and the operation information 184 will be described below.

The communicator 110 communicates with the terminal device 200 and other external devices via the network NW.

The registrant 120 registers information about the user U using the mobile object management system 1. Specifically, the registrant 120 receives information about the user U from the terminal device 200 and stores the received information in the user information 181 of the storage 180.

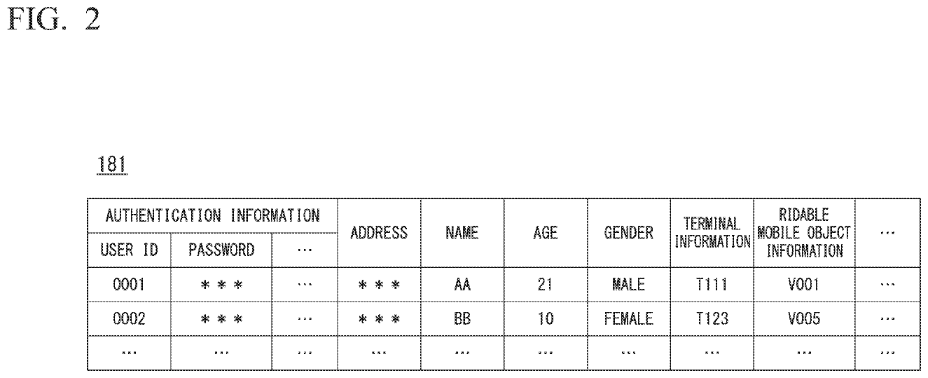

FIG. 2 is a diagram for describing content of the user information 181. The user information 181 is, for example, information in which an address, a name, age, gender, terminal information, ridable mobile object information, and the like are associated with authentication information for authenticating the user U at the time when the service of the mobile object management system 1 is used and the like. The authentication information includes, for example, identification information (for example, a user ID) for identifying the user U, a password, and the like. The authentication information may include biometric information such as fingerprint information and iris information. The terminal information includes, for example, identification information (for example, a terminal ID) for identifying the terminal device 200 owned by the user U within a theme park, a telephone number, an e-mail address, and the like. The ridable mobile object information includes, for example, identification information (for example, a mobile object ID) for identifying the ridable mobile object 300 communicating with the terminal device 200 of the user U in a near-field wireless communication scheme using Bluetooth or the like. The mobile object management server 100 communicates with the terminal device 200 on the basis of the terminal information, identifies the ridable mobile object 300 on the basis of the ridable mobile object information, and generates individual operation instructions. In the user information 181, for example, terminal information and ridable mobile object information of related certain users (for example, parents, children, and friends) are associated with each other.

For example, when a user registration request has been received from the terminal device 200, the registrant 120 generates an image for inputting various types of information included in the user information 181, causes the terminal device 200 that has received the request to display the generated image, acquires user information input from the terminal device 200, and registers the acquired user information in the user information 181.

The registrant 120 may authenticate the user U who uses the service of the mobile object management system 1 on the basis of the registered user information 181. In this case, the registrant 120 authenticates the user U, for example, at a timing when a service usage request has been received from the terminal device 200. For example, when the usage request has been received, the registrant 120 generates an authentication image for inputting authentication information such as a user ID and a password, causes the request terminal device 200 to display the generated image, and determines whether or not to permit use of the service according to whether the authentication information matching the input authentication information is stored with reference to the authentication information in the user information 181 on the basis of input authentication information input using the displayed image. For example, the registrant 120 permits the use of the service when the user information 181 includes authentication information matching the input authentication information and rejects the use of the service when the matching information is not included or performs a process of performing new registration.

The acquirer 130 acquires information about the ridable mobile object 300 that the user U is on. For example, when the terminal device 200 communicates with the ridable mobile object 300 in a near-field communication scheme such as Bluetooth, the acquirer 130 acquires identification information (for example, a mobile object ID) of the ridable mobile object 300 whose communication is in operation, identification information (for example, a terminal ID) of the terminal device 200, and a user ID from the terminal device 200. Subsequently, the acquirer 130 stores the terminal ID in the terminal information associated with the matching user ID with reference to the user ID of the user information 181 on the basis of the user ID and stores the mobile object ID in the ridable mobile object information. By iterating the above-described process at prescribed timings (for example, prescribed intervals), the mobile object management server 100 can manage a situation in which the ridable mobile object 300 is used.

The acquirer 130 acquires information about events implemented inside of the theme park. For example, the acquirer 130 acquires the event information 182 stored in the storage 180 in advance as the information about the events.

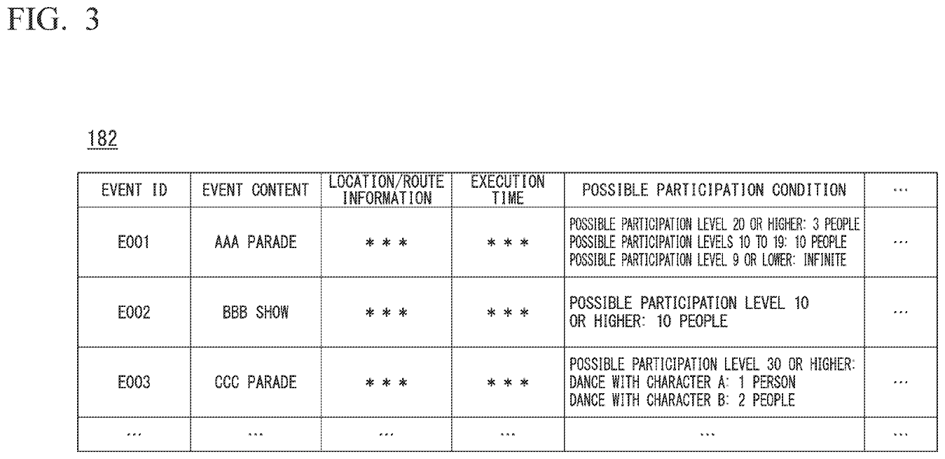

FIG. 3 is a diagram for describing content of the event information 182. The event information 182 is, for example, information in which event content, location/route information, execution time, possible participation conditions, and the like are associated with the event ID. The event ID is identification information for identifying an event to be executed in a theme park. The event content includes, for example, information of a title of the event, a type (a parade or a show), the number of cast members, music, participating cast members, and the like. The location/route information includes, for example, information about a location in a theme park where an event is executed and a route along which a parade marches. At least one piece of the event content and location/route information may include information about music that are output and luminescence in connection with the execution of the event, and an operation of the physical object related to the event (what type of motion is performed at which point). The execution time includes information about a time period and a day of the week when the event is executed and the duration of the event. Possible participation conditions are, for example, information about conditions under which the user U using the ridable mobile object 300 can participate in the event. For example, the possible participation conditions include the user's possible participation level, the number of people who can participate according to the level, and the like. The possible participation conditions may include a possible participation level or the number of participants who can dance with a specific character that participates in the event. The possible participation conditions may change, for example, for each specific period (e.g., Christmas or the user's birthday) or each season (summer or winter). Each piece of information included in the event information 182 may be obtained from, for example, an external device connected to the network NW, or may be input directly from the mobile object management server 100 by a server administrator.

For example, the acquirer 130 acquires location information of the terminal device 200 from the terminal device 200 of the user U on the ridable mobile object 300 (in other words, the terminal device 200 communicating with the ridable mobile object 300 in the near-field wireless communication scheme), and acquires the acquired location information as the location information of the ridable mobile object 300. The acquirer 130 iteratively acquires location information at prescribed intervals while the terminal device 200 and the ridable mobile object 300 are communicating.

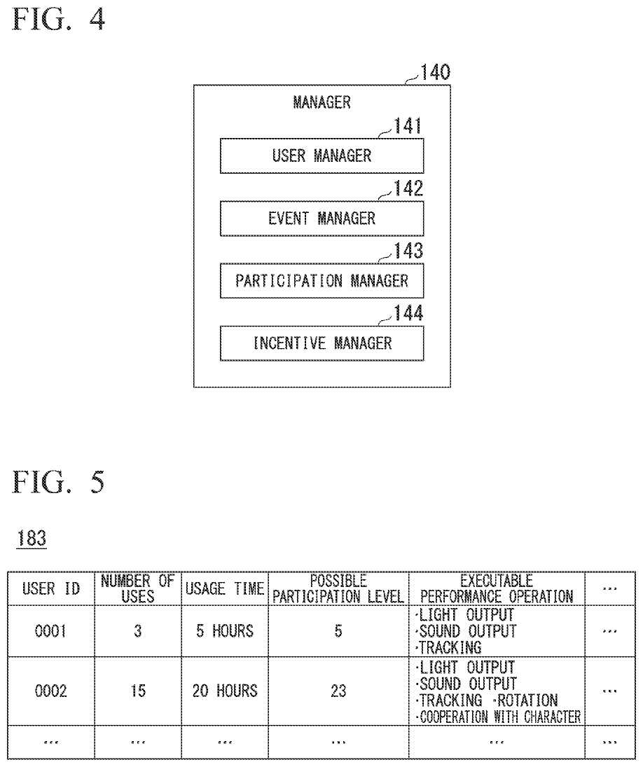

The manager 140 manages the entire mobile object management process in the mobile object management system 1. FIG. 4 is a diagram showing an example of a functional configuration of the manager 140. The manager 140 includes, for example, a user manager 141, an event manager 142, a participation manager 143, and an incentive manager 144.

For example, the user manager 141 manages the ridable mobile object 300 and the terminal device 200 of the user U on the ridable mobile object 300 in association with each other on the basis of the user information 181. The user manager 141 manages a situation in which the ridable mobile object 300 is used for each user U (for example, which ridable mobile object 300 the user U is currently on or the like) on the basis of the user information 181. The user manager 141 manages the location of the ridable mobile object 300 inside of the theme park on the basis of the information acquired by the acquirer 130. When prescribed users (for example, parents, children, and friends) are associated with each other in the user information 181, the user manager 141 may manage mutual location information of the terminal device 200 and the ridable mobile object 300 and the like.

The event manager 142 manages an event execution schedule on the basis of the event information 182 stored in the storage 180. The event manager 142 acquires information about an event to be held within a prescribed period of time from a current point in time with reference to the event information 182 and transmits the acquired information about content of the event and a route or location where the event is executed to the terminal device 200 and notifies the user U of the information. The event manager 142 determines the content of the event whose notification is provided to the user U in accordance with the possible participation level of the user U determined by the usage state of the ridable mobile object 300 of the user U. The usage state includes, for example, at least one of the number of uses and the usage time of the ridable mobile object 300 of the user U. The usage state may include information about a proficiency level of the user U for the ridable mobile object 300 in addition to the number of uses and the usage time. The proficiency level is an index value quantitatively expressing how familiar the user U is with using (manipulating) the ridable mobile object 300. The participation manager 143 sets the proficiency level for each user on the basis of, for example, the number of rotations of the ridable mobile object 300 in a prescribed period of time under the user's manipulation, a distance for stopping (sudden stopping) from a prescribed speed, and whether or not predetermined running (for example, straight running or figure-8 running) is possible. The proficiency level may be set on the basis of, for example, a degree of wobble of the ridable mobile object 300 under the user's manipulation and a frequency of input manipulations at the time of turning (e.g., the number of corrections in the case where the ridable mobile object 300 is bent more or less than expected when the body is tilted to change a traveling direction at a certain curvature). The degree of wobble and the frequency of input manipulations at the time of turning are acquired, for example, on the basis of a detection result of an attitude angle sensor provided in the ridable mobile object 300.

The participation manager 143 manages whether or not the user U can participate in the event, for example, on the basis of a state in which the user uses the ridable mobile object 300. For example, the participation manager 143 performs a management process of preventing the user U who does not satisfy the possible participation conditions of the event from participating in the event or a management process of preventing the user U from participating in an event exceeding the possible participation level of the user U or restricts participation in an event in which the user was able to participate in the past on the basis of elapsed time after the user previously participated in the event and/or elapsed time after the user previously rode the ridable mobile object 300. For example, the participation manager 143 performs a management process so that the guidance for the event, the inquiry about participation in the event, or the like is not performed for the user U below the possible participation level set under the possible participation conditions of the event.

The participation manager 143 manages the user U that participates in each event on the basis of information stored in the event information 182 and manages participation content and the like for each user U (for example, participation locations and performance operations in the parade). For example, the participation manager 143 adjusts the number of participation users to be less than or equal to the number of users who can participate on the basis of lottery, priority, or the like when the number of users who wish to participate exceeds the number of people whose participation is possible, for example, on the basis of the number of people whose participation is possible for each possible participation level included in the event information 182. After the user U participates in the event, the participation manager 143 updates the number of uses and usage time of the ridable mobile object 300 of the user U or performs a process of updating the possible participation level corresponding to the number of uses and the usage time. The participation manager 143 stores the above-described information as the usage history information 183 in the storage 180.

FIG. 5 is a diagram showing an example of content of the usage history information 183. In the usage history information 183 shown in FIG. 5, for example, the number of uses, usage time, a possible participation level, and an executable performance operation are associated with a user ID. The number of uses is the number of times the ridable mobile object 300 was used. For example, when the ridable mobile object 300 has moved a prescribed distance or more in a state in which the terminal device 200 of the user U and the ridable mobile object 300 are connected by near-field communication, the number of uses is counted as one. The number of uses may be the number of times the user U participated in the event while getting on the ridable mobile object 300 (the number of participations). The number of uses may be the number of participations for each event. The usage time is a period of time in which the user got on the ridable mobile object 300. For example, a period of time in which the terminal device 200 of the user U and the ridable mobile object 300 was connected by near-field communication is considered to be a period of time in which he or she got on the ridable mobile object 300. The usage time may be a period of time (a period of participation time) in which the user U participated in the event while getting on the ridable mobile object 300. The usage time may be the period of participation time for each event, or may be date and time information when the ridable mobile object 300 was used (for example, the year, month, and day, usage start time, and usage end time). The possible participation level is, for example, a level at which it is possible to participate in an event determined in accordance with at least one of the number of uses and the usage time. An executable performance operation is a performance operation that can be executed in an event set in accordance with the possible participation level. The performance operation includes, for example, an operation such as outputting light or sound, tracking an event character or the like, rotating, or linking with nearby characters or other mobile objects. The performance operation may include information about an event that became available for participation, a location of the user when participating in a parade, a show, or the like, and information about a character played by the user. In addition to the above-described information, the usage history information 183 may include information about content of a manipulation performed by the user U on the ridable mobile object 300 (for example, the number of rotations in a prescribed period of time, a sudden brake manipulation, straight running, figure-8 running, wobbling, a frequency of input manipulations at the time of turning, or the like) and information about a proficiency level of the user U for the ridable mobile object 300.

The participation manager 143 increases the possible participation level, for example, as the number of uses increases or the usage time increases. The participation manager 143 may increase the possible participation level in a level-up process when the number of uses is greater than or equal to a first threshold value and the usage time is greater than or equal to a second threshold value. In this case, the participation manager 143 increases the first threshold value or the second threshold value as the level increases. The participation manager 143 determines a performance operation that can be executed by the ridable mobile object 300 of the user U in accordance with the set possible participation level, stores the performance operation in the usage history information 183, and manages the performance operation. For example, the participation manager 143 increases the number of types of executable performance operations or enables a performance operation having a high rotational speed and a high moving speed as the possible participation level increases. For example, because the event information 182 includes a possible participation level under the possible participation conditions for each event, the number of events in which the user U can participate increases or the number of performance operations capable of being executed by the ridable mobile object 300 increases as the possible participation level of the user U increases. Thus, because the user U can participate in a desired event by increasing the level and can executing a desired performance operation, a motivation for participation in the event is further improved.

The participation manager 143 may restrict participation in an event in which the user U was able to participate in the past on the basis of at least one of elapsed time after the user U previously participated in the event (hereinafter referred to as first elapsed time) and elapsed time after the user U previously rode the ridable mobile object 300 (hereinafter referred to as second elapsed time). In this case, for example, the participation manager 143 applies a restriction so that participation in an event in which participation was possible in the past is impossible by deriving the first elapsed time and the second elapsed time from the usage time (previous usage end time) included in the usage history information 183 and decreasing the possible participation level of the user U as the first elapsed time and/or the second elapsed time of the user U increase. The participation manager 143 may apply a restriction so that participation in an event having an event ID “E001” that was able to participate in the past is disabled when the first elapsed time is greater than or equal to prescribed time or may apply a restriction so that participation in events having event IDs “E002” and “E003” that were able to participate in the past is disabled when the second elapsed time is greater than or equal to the prescribed time. The participation manager 143 may make an adjustment so that the number of uses or the usage time for increasing the level increases (or is lengthened) by increasing the above-described first or second threshold value and making an increase in the level difficult as the first elapsed time and/or the second elapsed time increases. Thus, when there is a gap (an interval) in the participation of the user U in the event or in riding of the user U of the ridable mobile object 300, it is possible to further improve the safety of the user U by limiting the number of events in which participation is possible until the user U gets used to riding of the ridable mobile object 300 (until the user U regains his or her senses). Because the user U willingly participates in the event or gets the ridable mobile object 300 so that he or she is not subject to the above-described restrictions, the utilization rate of the ridable mobile object 300 can be improved.

The participation manager 143 may update the proficiency level of the user U on the basis of manipulation content of the ridable mobile object 300 included in the usage history information 183 or may set the possible participation level together with the proficiency level in addition to the number of uses and the usage time described above. The participation manager 143 may transmit information about the possible participation level for each user U, information for raising the level, information for preventing the level from being lowered, and the like to the terminal device 200 of the user U and notify the user U of the information.

The incentive manager 144 manages incentives or the like given to a service provider side such as a provider of the ridable mobile object 300 rented to the user U or a planner who plans an event. The incentives in this case are, for example, equivalent to a service usage fee. The service usage fee may be collected from an admission fee of a theme park or may be collected via the terminal device 200 of the user U when he or she uses the ridable mobile object or participates in the event. The incentive manager 144 may manage the incentives given to the user U who participated in the event. As the incentives of this case, for example, the preferred ridable mobile object 300 is preferentially used, a rental fee for the ridable mobile object 300 is discounted, and award points are given.

The operation selector 150 selects content of a prescribed operation to be executed by the ridable mobile object 300 on the basis of location information of the ridable mobile object 300 located inside of the theme park and information about an event to be executed inside of the theme park. For example, the operation selector 150 selects an operation to be executed by the ridable mobile object 300 for each user U on the basis of a distance between a point where an event is executed (including a location on a route) and the ridable mobile object 300, event execution time, a possible participation level of the user U who participates in the event, participation content designated by the user U, and the like with reference to the user information 181 and the event information 182 stored in the storage 180.

For example, when an event is being executed and a distance between the event execution point and the ridable mobile object 300 that the user U participating in the event is on is within a prescribed distance, the operation selector 150 selects a prescribed operation corresponding to a performance corresponding to an event to be executed by the ridable mobile object 300. The operation selector 150 may select a prescribed operation to be executed by the ridable mobile object 300 when a distance between a physical object and the ridable mobile object 300 is within a prescribed distance on the basis of the distance between the physical object related to the event and the ridable mobile object 300. The operation selector 150 may select an operation for each of the ridable mobile objects 300 located inside of a specific range less than the theme park area in accordance with the number of ridable mobile objects 300 located inside of the specific range. The specific range includes, for example, a predetermined zone such as an adventure area or a park area located inside of a theme park and a range within a prescribed distance centered on a physical object related to the event. The operation selector 150 may select a prescribed operation to be executed on the basis of a condition obtained by combining a plurality of various types of conditions for selecting the above-described operation.

When specifically selecting the content of a prescribed operation, the operation selector 150 decides on specific content of a prescribed operation to be executed by the target ridable mobile object 300 on the basis of information associated with a matching event ID with reference to an event ID of the operation information 184 on the basis of an event ID of a target event satisfying the condition within the event information 182.

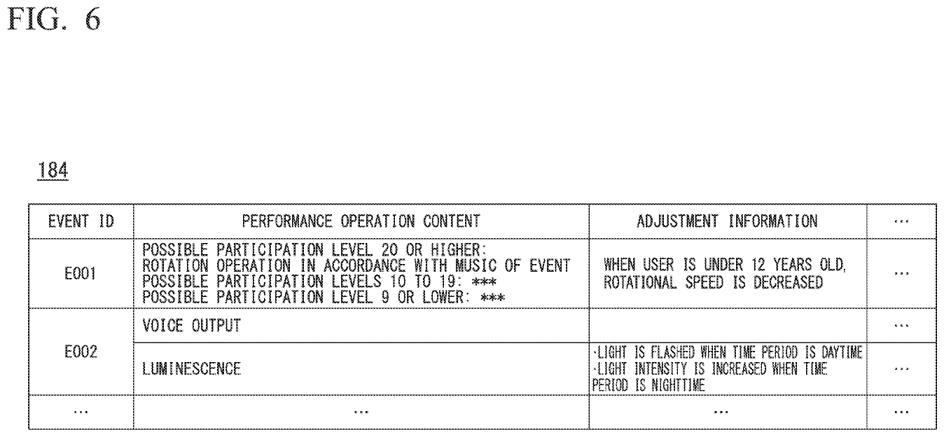

FIG. 6 is a diagram for describing content of the operation information 184. The content included in the operation information includes, for example, music output in connection with the execution of the event, luminescence, or a performance operation according to an operation of a physical object related to the event. The operation information 184 is, for example, information in which performance operation content and adjustment information are associated with the event ID. The performance operation content includes the operation content of the ridable mobile object 300. The performance operation content may be set for each possible participation level set for each event. In the example of FIG. 6, the ridable mobile object 300 is rotated in accordance with the music output at the time of the event if the possible participation level is 20 or more when the event ID is “E001” or a performance operation for outputting a voice or emitting light is performed when the event ID is “E002.”

The adjustment information is, for example, information for adjusting a part of an operation in accordance with information about the user U, a surrounding environment, and the like with respect to the operation set in the operation content. Information about the user U is information (e.g., age or gender) obtained from the user information 181. The information about the surrounding environment is, for example, information acquired from the event information 182 (for example, location/route information or execution time). In the example of FIG. 6, information indicating that a rotational speed is reduced when the user is under 12 years old, a light emitter performs flashing when a time period is daytime (for example, 10:00 to 17:59), and a light intensity of the light emitter is increased when a time period is nighttime (18:00 to 21:00) is shown as adjustment information. The performance operation content and adjustment information are not limited to the example of FIG. 6. For various types of events, each of movement (rotation or the like) of the ridable mobile object 300, a voice output, and luminescence or a performance operation of a combination thereof may be set.

The event operation instructor 160 generates an operation instruction for the event for the target ridable mobile object 300 on the basis of the operation content decided on (selected) by the operation selector 150. For example, the event operation instructor 160 generates an operation instruction for causing a ridable mobile object 300 that the user U participating in the event gets on and which is located within a prescribed distance from an execution point at the time when the event is executed to execute a prescribed event operation. The event operation instructor 160 may adjust content of an operation of the event (including a degree of operation) on the basis of adjustment information and adjust content of an operation of the event on the basis of setting content (adjustment information) of the user U acquired from the terminal device 200.

The event operation instructor 160 acquires terminal information of the terminal device 200 of the user U on the target ridable mobile object 300 on the basis of the terminal information of the user information 181 and transmits the generated or adjusted operation instruction to the terminal device 200 on the basis of the acquired terminal information. The event operation instructor 160 may transmit map information of an area (a theme park) and the like to the terminal device 200 in addition to (or in place of) the operation instruction.

### [Terminal Device]

Next, a configuration of the terminal device 200 will be described. FIG. 7 is a configuration diagram of the terminal device 200 of the embodiment. The terminal device 200 includes, for example, a terminal-side communicator 210, an input 220, an output 230, a location information acquirer 240, an application executor 250, an output controller 260, and a terminal-side storage 270. The location information acquirer 240, the application executor 250, and the output controller 260 are implemented by, for example, a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (a non-transitory storage medium) such as a DVD or a CD-ROM and installed in the storage device of the terminal device 200 when the storage medium is mounted in a drive device, a card slot, or the like.

The terminal-side storage 270 may be implemented by the above-described various types of storage devices, an EEPROM, a ROM, a RAM, or the like. The terminal-side storage 270 stores, for example, a mobile object management application 272, a program, and various other types of information. The terminal-side storage 270 may store user information such as a terminal ID and a user ID or may store map information acquired from the mobile object management server 100 or the like.

The terminal-side communicator 210 communicates with the mobile object management server 100, the ridable mobile object 300, and other external devices using, for example, the network NW. The terminal-side communicator 210 may perform wireless communication on the basis of, for example, Wi-Fi, Bluetooth, dedicated short range communication (DSRC), or other communication standards or may have a near-field communication function of performing near-field communication (NFC) with the ridable mobile object 300.

The input 220 receives an input of the user U by, for example, a manipulation on various types of keys and buttons. The input 220 may include a motion sensor that detects an operation of the terminal device 200 and may receive an input of the user U on the basis of the operation of the terminal device body detected by the motion sensor (for example, an operation in which the user U shakes or turns the terminal device 200). The input 220 includes an audio input such as a microphone and a voice of the user U and a sound around the terminal device 200 are input by the audio input and the input of the user U may be accepted by analyzing the input sound. The output 230 outputs information to the user U. The output 230 is, for example, a display or a speaker (an audio output). The display is, for example, a liquid crystal display (LCD), an organic electro-luminescence (EL) display, or the like. The input 220 may be integrally configured with the display as a touch panel. The display displays various types of information according to the embodiment under the control of the output controller 260. For example, the speaker outputs a prescribed sound (a voice, music, an alarm sound, a sound effect, or the like) under the control of the output controller 260.

The location information acquirer 240 acquires location information of the terminal device 200 by, for example, a built-in Global Positioning System (GPS) device (not shown). The location information includes, for example, latitude and longitude.

The application executor 250 is implemented by executing the mobile object management application 272 stored in the terminal-side storage 270. For example, the mobile object management application 272 is downloaded from an external device via a network NW and installed on the terminal device 200. The mobile object management application 272 is an application program for controlling the output controller 260 so that the user U causes the display to output an image provided by the mobile object management server 100 or causes a voice corresponding to the information provided by the mobile object management server 100 to be output from the speaker.

The application executor 250 transmits information input by the input 220, information stored in the terminal-side storage 270, or the like to the mobile object management server 100 or the ridable mobile object 300 via the terminal-side communicator 210. The information input by the input 220 includes, for example, information about registration and authentication of the user U, adjustment information of an operation by the user U when the ridable mobile object 300 operates in response to an event, and the like. The application executor 250 transmits information obtained from the mobile object management server 100, location information of the terminal device 200, map information, and the like to the ridable mobile object 300 that the user U is on or transmits information obtained from the ridable mobile object 300 to the mobile object management server 100 together with a user ID or location information.

The output controller 260 controls the content and display mode of an image to be displayed on the display of the output 230 and the content and output mode of a voice to be output by the speaker according to control of the application executor 250.

### [Ridable Mobile Object]

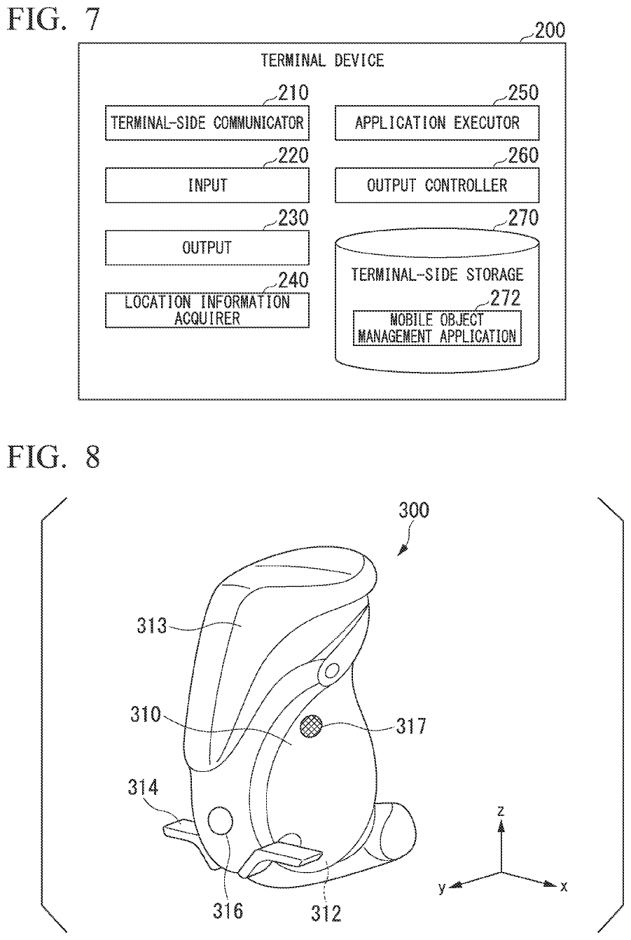

Next, the ridable mobile object 300 will be described. FIG. 8 is a perspective view showing the appearance of the ridable mobile object 300 of the embodiment. In FIG. 8, a width direction of the ridable mobile object 300 is referred to as an x-direction, a forward-rearward direction thereof is referred to as a y-direction, and an upward-downward direction thereof is referred to as a z-direction. The forward direction of the ridable mobile object 300 is a positive direction of a y-axis and the rearward direction thereof is a negative direction of the y-axis. The ridable mobile object 300 shown in FIG. 8 includes, for example, a mobile object body 310, an omnidirectional moving wheel 312, a seat 313, and steps 314. The inside of the mobile object body 310 is covered, for example, with a resin cover panel or the like. The internal configuration of the mobile object body 310 will be described below.

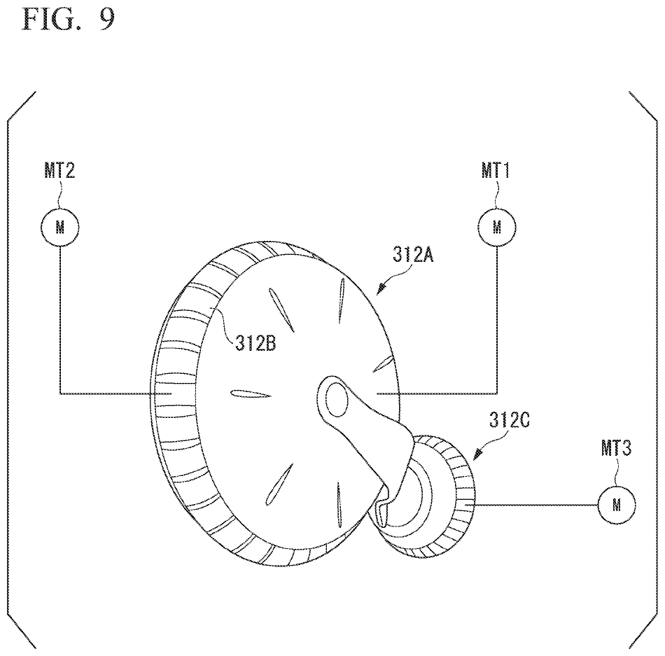

FIG. 9 is a perspective view of the omnidirectional moving wheel 312. The omnidirectional moving wheel 312 includes a large-diameter wheel 312A, a small-diameter wheel 312B, a turning wheel 312C, a first motor MT1, a second motor MT2, and a third motor MT3. The large-diameter wheel 312A is a wheel that can rotate around the x-axis. The large-diameter wheel 312A is rotated by the first motor MT1.

The small-diameter wheel 312B is a wheel that can rotate around an axis orthogonal to a straight line in a radial direction in the central cross-section in the width direction of the large-diameter wheel 312A. The omnidirectional moving wheel 312 includes a plurality of small-diameter wheels 312B. The plurality of small-diameter wheels 312B are disposed at substantially equal intervals along a circumferential direction of the large-diameter wheel 312A. The plurality of small-diameter wheels 312B are partially or wholly rotated at the same time by, for example, the second motor MT2.

The turning wheel 312C is a wheel that can rotate around the y-axis. The turning wheel 312C has a smaller diameter than the large-diameter wheel 312A. The turning wheel 312C is rotated by the third motor MT3. The omnidirectional moving wheel 312 moves the ridable mobile object 300 by rotating at least one of the large-diameter wheel 312A, the small-diameter wheels 312B, and the turning wheel 312C. An operation of the omnidirectional moving wheel 312 will be described below.

Referring back to FIG. 8, the seat 313 is attached above the mobile object body 310. The seat 313 is a member on which the user U on the ridable mobile object 300 is sitting. The steps 314 are attached to a lower anterior portion of the mobile object body 310. The steps 314 are members on which the user U places his or her legs. The seat 313 and the steps 314 are adjustable in width and height.

The ridable mobile object 300 may include a light emitter 316 such as a lamp, a speaker 317 that outputs a voice, or the like. The light emitter 316 can perform lighting or flashing in one or more prescribed colors. The speaker 317 outputs a prescribed sound (a voice, music, a warning sound, a sound effect, or the like). It is only necessary for the light emitter 316 and the speaker 317 to be attached to any one or more locations on the ridable mobile object 300, and the attachment locations thereof are not limited to the attachment locations shown in FIG. 8.

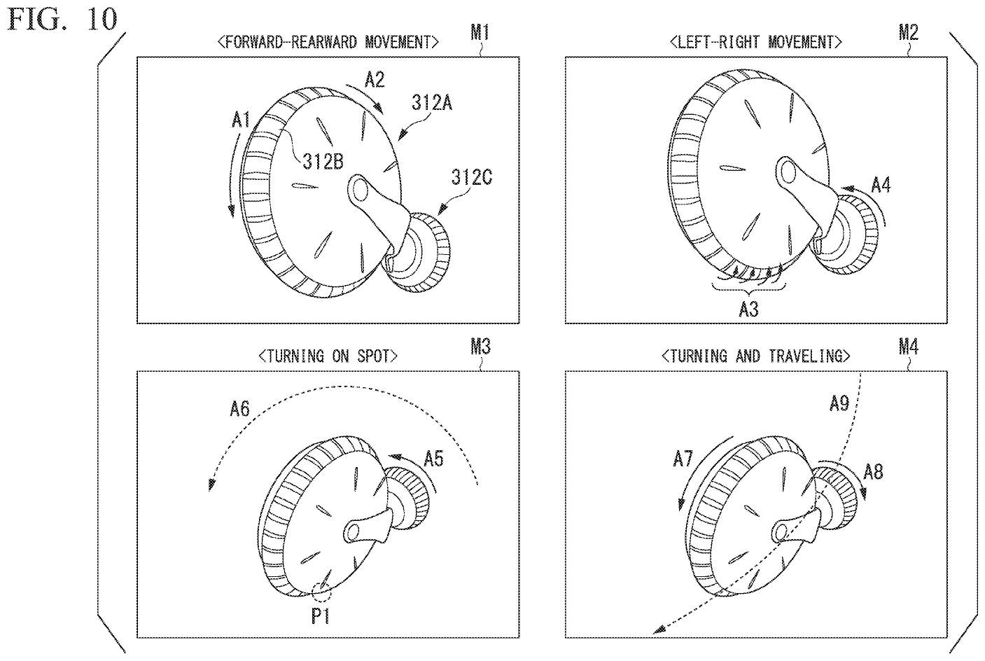

Subsequently, details of the operation of the omnidirectional moving wheel 312 of the ridable mobile object 300 will be described. FIG. 10 is a diagram for describing details of the operation of the omnidirectional moving wheel 312 of the ridable mobile object 300. The omnidirectional moving wheel 312 is a wheel that enables the ridable mobile object 300 to immediately advance in any direction (all directions of 360 degrees) from a current location without performing a preliminary operation such as turning. The omnidirectional moving wheel 312 includes, for example, the large-diameter wheel 312A serving as a front wheel and the turning wheel 312C serving as a rear wheel, and the plurality of small-diameter wheels 312B are provided on a ground contact portion (a diametrical edge portion) of the large-diameter wheel 312A that is the front wheel.

The large-diameter wheel 312A is a wheel that mainly implements straight-ahead movement in the forward-rearward direction. The small-diameter wheel 312B is a wheel that mainly implements lateral movement on the spot by rotating around a rotation direction (a circumferential direction) of the large-diameter wheel 312A as an axis. On the other hand, the turning wheel 312C, which is the rear wheel, has a smaller diameter than the large-diameter wheel 312A and is a wheel that mainly implements turning movement by rotating on a rotation axis orthogonal to the rotation axis of the large-diameter wheel 312A.

The omnidirectional moving wheel 312 includes motors MT1 to MT3 that can independently control the rotations of the large-diameter wheel 312A, the small-diameter wheel 312B, and the turning wheel 312C described above. According to this configuration, the omnidirectional moving wheel 312 can also implement agile movements such as bending and turning on the spot as well as movements in various directions such as a right-lateral direction and a diagonal direction using a lateral movement speed difference of the front and rear wheels in addition to the front-rear movement.

Here, the forward direction of the ridable mobile object 300 is the positive direction of the y-axis (a +y-axis direction) in FIG. 8 and the rearward direction is the negative direction of the y-axis (a −y-axis direction) therein. For example, as shown in an operation example M1 (forward movement/rearward movement) of FIG. 10, the omnidirectional moving wheel 312 moves forward by rotating the large-diameter wheel 312A in a direction of an arrow A1 and moves rearward by rotating the large-diameter wheel 312A in a direction of an arrow A2.

As shown in an operation example M2 (left-right movement) of FIG. 10, the omnidirectional moving wheel 312 can move in the left direction on the spot without changing the direction by rotating the small-diameter wheels 312B in a direction of an arrow A3. In this case, the turning wheel 312C may be configured to rotate naturally in a direction of an arrow A4 according to the movement in the left-right direction or may be controlled to rotate in the direction of the arrow A4 in accordance with an amount of rotation of the small-diameter wheels 312B. The omnidirectional moving wheel 312 can move in the right direction on the spot without changing the direction by rotating the small-diameter wheels 312B in a direction opposite to the arrow A3. The left direction mentioned here corresponds to a positive direction of the x-axis (a +x-axis direction) in FIG. 8 and the right direction is the right direction in FIG. 8 and corresponds to a negative direction of the x-axis (a −x-axis direction) in FIG. 8. The plurality of small-diameter wheels 312B may be configured so that all the wheels rotate simultaneously or may be configured so that only the wheels of the ground contact portion rotate.

As shown in an operation example M3 (turning on the spot) of FIG. 10, the omnidirectional moving wheel 312 can turn in a direction of an arrow A6 on the spot in a state in which the ground contact point P1 of the large-diameter wheel 312A is designated as the center by rotating the turning wheel 312C in a direction of an arrow A5 and can turn in a direction opposite to the arrow A6 on the spot by rotating the turning wheel 312C in a direction opposite to the arrow A5.

As shown in an operation example M4 (turning and traveling) of FIG. 10, the omnidirectional moving wheel 312 can move forward while turning in a direction of an arrow A9 by rotating the large-diameter wheel 312A in a direction of an arrow A7 and rotating the turning wheel 312C in a direction of an arrow A8 (turning and traveling). The omnidirectional moving wheel 312 can move rearward while turning in a direction opposite to the arrow A9 by rotating the large-diameter wheel 312A in a direction opposite to the arrow A7 and rotating the turning wheel 312C in the direction of the arrow A8. In this example, the omnidirectional moving wheel 312 can move forward or rearward while keeping the turning center on the right side by rotating the turning wheel 312C in a direction opposite to the arrow A8.

A method of implementing the omnidirectional moving wheel 312 is not limited to the method of FIG. 10. The omnidirectional moving wheel 312 may be implemented with any existing technology. The ridable mobile object 300 may include one omnidirectional moving wheel 312 or may include a plurality of omnidirectional moving wheels 312. Further, the ridable mobile object 300 may include ordinary wheels as auxiliary wheels in addition to the omnidirectional moving wheel 312.

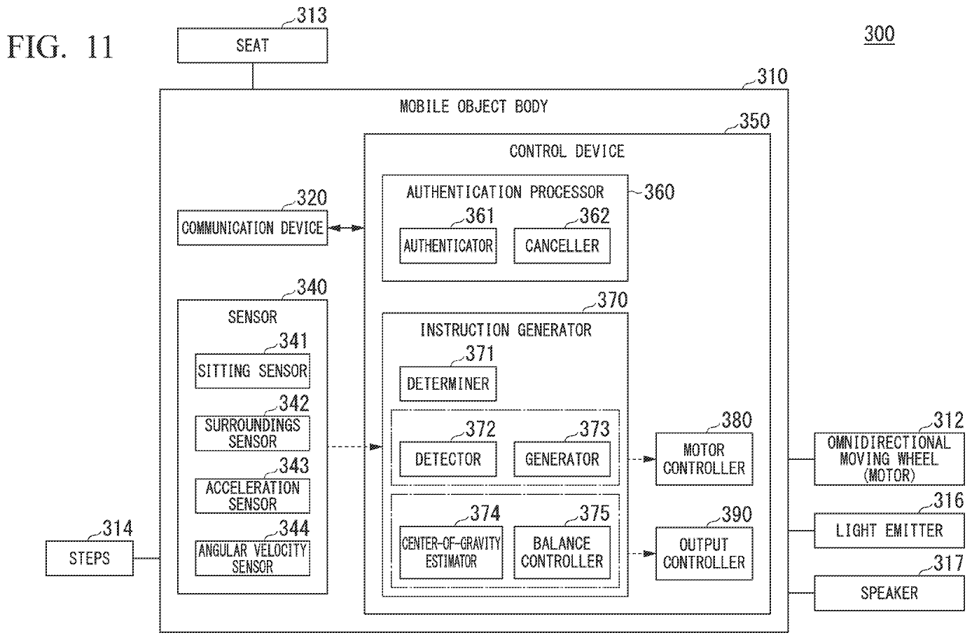

Next, a functional configuration of the ridable mobile object 300 will be described. FIG. 11 is a configuration diagram showing an example of the ridable mobile object 300 of the embodiment. The ridable mobile object 300 shown in FIG. 11 includes, for example, a communication device 320, a sensor 340, and a control device 350. The communication device 320, the sensor 340, and the control device 350 are provided, for example, inside of the mobile object body 310. In addition to the mobile object body 310, the ridable mobile object 300 includes, for example, the omnidirectional moving wheel 312, the seat 313, the steps 314, the light emitter 316, and the speaker 317.

The communication device 320 performs wireless communication on the basis of, for example, Wi-Fi, Bluetooth, DSRC, and other communication standards. The communication device 320 receives an electrical signal transmitted by the terminal device 200 and outputs the electrical signal to the control device 350. The communication device 320 transmits an electrical signal output by the control device 350 to the terminal device 200. In place of or in addition to the communication device 320, a near-field communication function of executing near-field communication (NFC) with the terminal device 200 may be provided.

The sensor 340 includes, for example, a sitting sensor 341, a surroundings sensor 342, an acceleration sensor 343, and an angular velocity sensor 344. The sitting sensor 341 detects a sitting state of whether or not the user U (a rider) is sitting on the seat 313. The sitting sensor 341 outputs a sitting signal indicating the sitting state of the user U to the control device 350.

The surroundings sensor 342 is a sensor that detects a physical object in the vicinity of the ridable mobile object 300. The surroundings sensor 342 detects, for example, a distance between the detected physical object and the ridable mobile object 300. The surroundings sensor 342 outputs a nearby physical object signal related to the detected physical object and the distance between the detected physical object and the ridable mobile object 300 to the control device 350. The surroundings sensor 342 may be, for example, an ultrasonic sensor using ultrasonic waves as a medium, an optical sensor using light as a medium, or an image sensor that captures an image of the surroundings of the ridable mobile object 300.

The acceleration sensor 343 is attached to any location on one or both of the mobile object body 310 and the seat 313. The acceleration sensor 343 detects the acceleration acting on the attachment location and outputs the acceleration to the control device 350. The angular velocity sensor 344 (a gyro sensor) is also attached to any location on one or both of the mobile object body 310 and the seat 313. The angular velocity sensor 344 detects an angular velocity acting on the attachment location and outputs the angular velocity to the control device 350. In addition to the above-described sensors, the sensor 340 may include an attitude angle sensor that detects the attitude angle (inclination) of the ridable mobile object 300.

The control device 350 controls an operation of the ridable mobile object 300 on the basis of information obtained from the communication device 320 and the sensor 340 and the like. The control device 350 includes, for example, an authentication processor 360, an instruction generator 370, a motor controller 380, and an output controller 390. The authentication processor 360 includes, for example, an authenticator 361 and a canceller 362. The instruction generator 370 includes, for example, a determiner 371, a detector 372, a generator 373, a center-of-gravity estimator 374, and a balance controller 375.

These components are implemented, for example, by a hardware processor such as a CPU executing a program (software). Some or all of the above components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory in the ridable mobile object 300 or may be stored in a removable storage medium (a non-transitory storage medium) such as a DVD or a CD-ROM and installed in the storage device when the storage medium is mounted in a drive device. The storage device may store a mobile object ID assigned to its own vehicle, a terminal ID obtained from the terminal device 200, location information, map information, operation instructions, and the like.

The authenticator 361 authenticates the user U who will get on (or is on) the ridable mobile object 300. The authenticator 361 performs near-field communication with the terminal device 200 located nearby (within a prescribed distance) using Bluetooth or the like and the terminal device 200 where communication is first established or the nearest terminal device 200 acquires information about the terminal device 200 (for example, a terminal ID or a user ID) and the usage authority is set for the user U who has the terminal device 200 on the basis of the acquired information. The authenticator 361 may perform the above-described authentication, for example, when the sitting sensor 341 determines that the user U is sitting on the seat 313. In a state in which the usage authority is set, the authenticator 361 is in communication with the terminal device 200 and the ridable mobile object 300. The authenticator 361 does not communicate with other terminal devices 200 when the usage authority is set for one user U (when the usage authority is not canceled) (i.e., the usage authority is not set for a plurality of users at the same time).

The canceller 362 measures elapsed time after the user U leaves the ridable mobile object 300. The canceller 362 cancels the authority of the user U to use the ridable mobile object 300 by determining that a cancellation condition is satisfied when a prescribed time has elapsed after the user U left the ridable mobile object 300. The prescribed time may be uniform or may fluctuate according to specific conditions. The specific conditions may be, for example, a stop location of the ridable mobile object 300, a time period, the number of people who visit a specific area with the user U, human relationships such as family members and friends, and the like. The cancellation condition may be any other condition. For example, the user U may perform a manipulation indicating his or her intention to cancel the usage authority and a condition that the canceller 362 has acquired a signal corresponding to the manipulation may be used as a cancellation condition. The canceller 362 may compare an operation of the ridable mobile object 300 (hereinafter referred to as an actual operation) based on the user's manipulation after the authentication of the authenticator 361 with an operation associated with the possible participation level of the user U (hereinafter referred to as a level operation) and may cancel the authority of the user U to use the ridable mobile object 300 when the actual operation has not reached the level operation or may add a usage restriction so that some manipulations are unable to be executed. Thereby, it is possible to further improve the safety of the user U by preventing another person from using the terminal device 200 while impersonating the user U due to the transfer or theft of the terminal device 200 or by limiting the use of the user U when there is a gap in riding of the ridable mobile object 300.

For example, the instruction generator 370 generates instructions for operation control and output control for the ridable mobile object 300. The determiner 371 determines whether or not the user U is sitting on the basis of a sitting signal output by the sitting sensor 341. When the determiner 371 determines that the user U is sitting on the seat 313 according to the sitting signal and then determines that the user U is not sitting on the seat 313, the determiner 371 may determine that the user U has left the ridable mobile object 300.

The detector 372 detects information about the manipulation content of the user U for the ridable mobile object 300 and the event acquired from the terminal device 200 (an event operation instruction). The detector 372 may detect a surrounding situation of the ridable mobile object 300 detected by the surroundings sensor 342. The surrounding situation is, for example, the behavior of other ridable mobile objects 300 that are located nearby and characters and vehicles that are parading or the like.

The generator 373 generates an event operation instruction for the ridable mobile object 300. For example, the generator 373 generates an event operation instruction corresponding to an event such as a parade or a show that is performed nearby on the basis of the event operation instruction generated by the mobile object management server 100 acquired via the terminal device 200. The event operation instruction to be generated is, for example, an instruction for driving the omnidirectional moving wheel 312 by the motor controller 380, causing the light emitter 316 to perform lighting or flashing in a prescribed color by the output controller 390, or outputting a prescribed sound from the speaker (the audio output), for example, according to an operation instruction from the mobile object management server 100. The generator 373 may generate an operation instruction for moving the ridable mobile object 300 so that the ridable mobile object 300 does not come into contact with a nearby physical object obtained from the surroundings sensor 342. The generator 373 outputs control information based on the generated operation instruction (including an event operation instruction) to the motor controller 380 and the output controller 390.

The center-of-gravity estimator 374 and the balance controller 375 mainly function when the user U is on the ridable mobile object 300. The center-of-gravity estimator 374 estimates the center of gravity of a physical object including the user U on the ridable mobile object 300, the mobile object body 310, and the seat 313 on the basis of outputs of the acceleration sensor 343 and the angular velocity sensor 344.

The balance controller 375 generates control information (an operation instruction) in a direction in which a location of the center of gravity estimated by the center-of-gravity estimator 374 is returned to a reference location (a center-of-gravity location in a stationary state). For example, when the location of the center of gravity is biased to the right backward from the reference location, the balance controller 375 generates information indicating acceleration toward the right rear as control information. When a manipulation (an action instruction) by the user U is accelerated forward movement and the location of the center of gravity is behind the reference location, the balance controller 375 may suppress acceleration so that the location of the center of gravity is not biased further back by the accelerated forward movement or may start the accelerated forward movement after rearward movement is performed once and the location of the center of gravity moves forward through guidance. The instruction generator 370 outputs control information (an operation instruction) generated by the balance controller 375 to the motor controller 380.

The motor controller 380 individually controls each motor attached to the omnidirectional moving wheel 312 on the basis of the control information output by the instruction generator 370. For example, in the motor controller 380, different control processes may be executed when the user U is on the ridable mobile object 300 and when the user U is and is not (sitting) on the ridable mobile object 300.

When the user U is on the ridable mobile object 300, the above-described control can cause the ridable mobile object 300 to move in a desired direction when the user U on the ridable mobile object 300 moves the center of gravity in the desired direction according to a change in his or her own posture. That is, the ridable mobile object 300 recognizes the center-of-gravity movement of the user U as a maneuvering manipulation on the ridable mobile object 300 and performs a movement operation corresponding to the maneuvering manipulation.

The output controller 390 causes the light emitter 316 to perform lighting or flashing in a prescribed color or causes the speaker 317 to output a prescribed sound (a voice, music, a warning sound, a sound effect, or the like) on the basis of the control information output by the instruction generator 370.

A function to be executed by the ridable mobile object 300 is executed by electric power supplied from a battery (not shown) mounted thereinside. The battery may be charged by a charging device provided outside of the ridable mobile object 300 or may be detachable so that it can be replaced with another battery. The battery can also be charged with electricity regenerated by a motor of the omnidirectional moving wheel 312.

### [Process to be Executed by Mobile Object Management System]

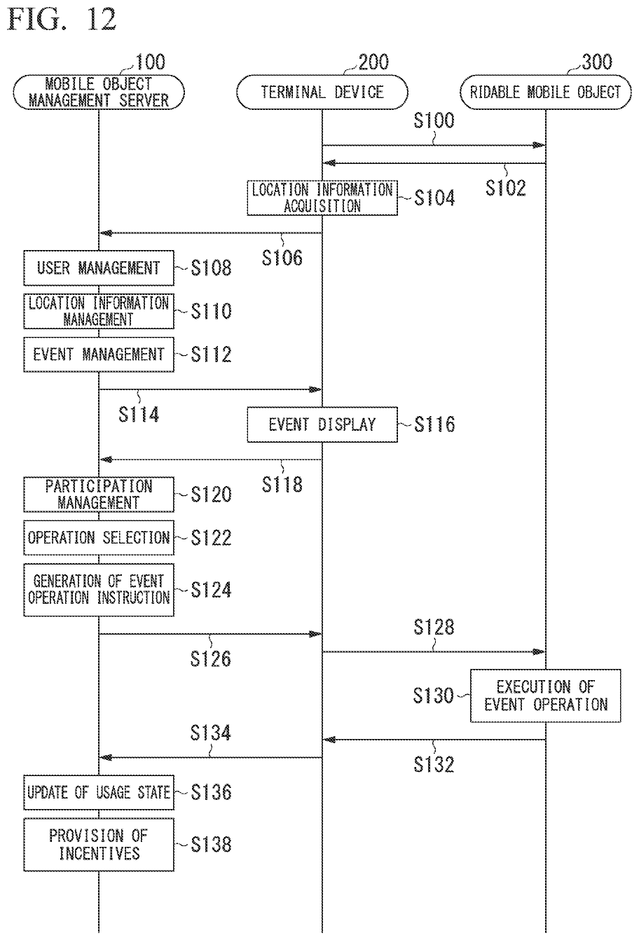

Next, a process executed by the mobile object management system 1 will be described. FIG. 12 is a sequence diagram showing an example of a process executed by the mobile object management system 1. In the example of FIG. 12, for convenience of description, description will be given using one mobile object management server 100, a terminal device 200, and a ridable mobile object 300. In the example of FIG. 12, a process when the ridable mobile object 300 participates in an event executed within a prescribed area will be mainly described. In the example of FIG. 12, it is assumed that an authentication process is performed between the terminal device 200 and the mobile object management server 100 and the user U of the terminal device 200 is permitted to use a service provided by the mobile object management system 1.

In the example of FIG. 12, the terminal device 200 communicates with the ridable mobile object 300 in a near-field communication scheme using Bluetooth or the like when the user U has gotten on the ridable mobile object 300 (step S100) and the identification information (the mobile object ID) of the ridable mobile object 300 is acquired when the use of the ridable mobile object 300 has been permitted (the communication has been established) (step S102). Subsequently, the location information acquirer 240 of the terminal device 200 acquires the location information of the terminal device 200 (step S104). Subsequently, the terminal device 200 transmits the acquired location information, the user ID, the terminal ID, and the mobile object ID to the mobile object management server 100 (step S106).

The mobile object management server 100 performs a user management process by receiving information from the terminal device 200 and storing a terminal ID and a mobile object ID in the user information 181 in association with a user ID matching the received user ID with reference to the user ID of the user information 181 (step S108). The mobile object management server 100 manages the location information of the terminal device 200 acquired by the terminal device 200 as the location information of the ridable mobile object 300 (step S110). The processing of steps S104 to S110 may be iteratively executed at prescribed intervals while the terminal device 200 and the ridable mobile object 300 are connected by near-field communication.

Subsequently, the mobile object management server 100 manages an event execution schedule with reference to the event information 182 and acquires information about an event that is held within a prescribed time from a present point in time (for example, content, location/route information, execution time, or information about a possible participation condition of the user U associated with the event) (step S112). Subsequently, the mobile object management server 100 transmits the information about the event to the terminal device 200 (step S114). In the processing of step S114, the mobile object management server 100 may acquire a possible participation level for each user U with reference to the usage history information 183 and transmit information about an event to the user U whose possible participation level satisfies a possible participation condition.

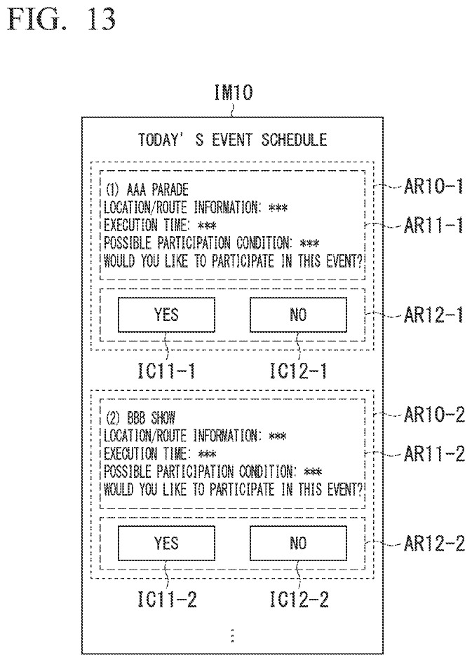

The terminal device 200 causes the output 230 (the display) to display the information about the event received from the mobile object management server 100 (step S116). FIG. 13 is a diagram showing an example of an image IM10 displayed on the display of the terminal device 200. A display mode such as a layout of an image IM10 or display content thereof is not limited to the example of FIG. 13. The same is also true for other images to be described below. The image IM10 shows, for example, today's event schedule to be executed at a theme park. The image IM10 includes, for example, an event content display area AR10 for each event. The event content display area AR10 includes, for example, a detailed information display area AR11 and a switch display area AR12. In the detailed information display area AR11, information about event content, location/route information, execution time, and possible participation conditions stored in the event information 182 is displayed. The switch display area AR12 includes, for example, icons IC11 and IC12. The icon IC11 is a graphical user interface (GUI) switch for accepting participation in an event from a user. The icon IC12 is a GUI switch for accepting non-participation in an event from the user U. When the icon IC11 or the icon IC12 has been selected, the terminal device 200 transmits received information to the mobile object management server 100 (step S118).

When the mobile object management server 100 receives information indicating that the user will participate in the event from the user U of the terminal device 200, the mobile object management server 100 manages the participation of the user U in the event (step S120). The mobile object management server 100 selects the operation of the ridable mobile object 300 that the user U gets on in accordance with the event in which the user U participates or the possible participation level (step S122). The mobile object management server 100 may ask the user U about participation content if a plurality of different pieces of participation content are included in a selected event in which the user U will participate.

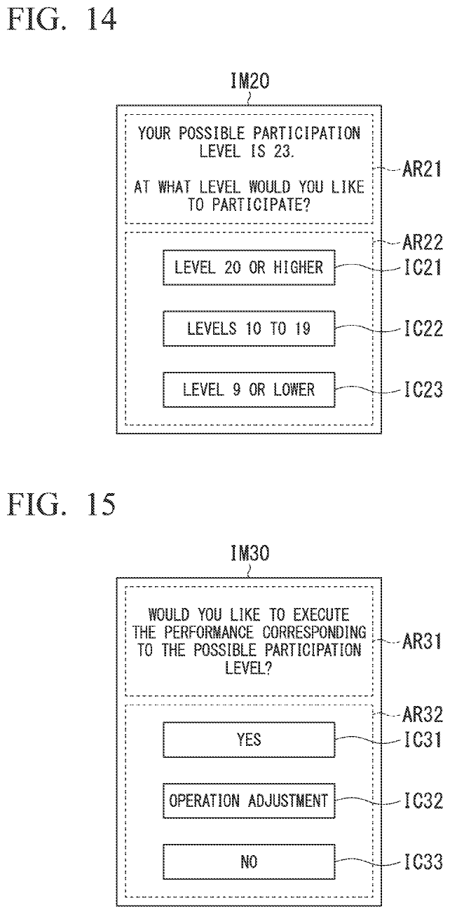

FIG. 14 is a diagram showing an example of an image IM20 for asking a user about specific participation content. The image IM20 includes, for example, a level information display area AR21 and a switch display area AR22. In the level information display area AR21, for example, information about a current possible participation level of the user acquired from the usage history information 183 is displayed. In the example in FIG. 14, in the level information display area AR21, text information such as “Your possible participation level is 23. At what level would you like to participate?” is displayed.

In the switch display area AR22, icons IC21 to IC23 for selecting any one of pieces of possible participation content set for each participation event are displayed. In the example of FIG. 14, in the switch display area AR22, the icon IC21 for participating in a performance operation of “possible participation level 20 or higher,” the icon IC22 for participating in performance operations of “possible participation levels 10 to 19,” and the icon IC23 for participating in a performance operation of “possible participation level 9 or lower,” which are possible participation conditions corresponding to the event ID “E001,” are displayed. The user U can participate in the event with the performance operation desired by the user U by selecting the desired participation icon from the icons IC21 to IC23. Selected information is transmitted from the terminal device 200 to the mobile object management server 100.

The mobile object management server 100 may ask the user U about whether or not to execute a performance operation corresponding to the user's current possible participation level for the user U who participates in the event. FIG. 15 is a diagram showing an example of an image IM30 for asking the user U about the performance operation. The image IM30 shown in FIG. 15 includes, for example, an inquiry display area AR31 and a switch display area AR32. In the inquiry display area AR31, inquiry content (for example, text) for confirming whether or not the performance operation is executed by the user U is displayed. In the example of FIG. 15, text information such as “Would you like to execute the performance corresponding to the possible participation level?” is displayed in the inquiry display area AR31. The switch display area AR32 includes, for example, icons IC31, IC32, and IC33. The icon IC31 is a graphical user interface (GUI) switch for accepting the permission of a performance operation corresponding to the possible participation level. The icon IC32 is a GUI switch for accepting the transition to a screen for adjusting the performance operation (detailed setting). The icon IC33 is a GUI switch for accepting that a performance corresponding to the participation condition level is not performed (or is denied).

When the icon IC31 has been selected, for example, a performance operation corresponding to the possible participation level of the user U or the level selected by the user U from the image IM20 shown in FIG. 14 is executed. When the icon IC32 has been selected, for example, the screen transitions to a screen for determining whether or not a turning operation (a rotation operation) is to be performed by the ridable mobile object 300 or allowing the user U to adjust the acceleration or deceleration of the turning speed, the presence or absence of voice output, and the presence or absence of luminescence by the light emitter. Thereby, the user U can set details of the performance operation according to his or her preferences and the surrounding environment. For example, if there are many people nearby, because the turning operation or the luminescence is likely to cause trouble to others, the user U can enjoy the performance without causing trouble to others by making an adjustment for suppressing the operation or output such as decreasing the turning speed below the standard speed or decreasing the emitted light intensity according to his or her own determination. In contrast, when there are no people around, the turning speed is accelerated above the reference speed or an emitted light intensity is adjusted to a high intensity. When the icon IC32 has been selected, for example, an operation for a turning speed or the like and an output for an emitted light intensity or the like may be automatically adjusted in accordance with the presence or absence of a nearby physical object obtained from the surroundings sensor 342 and a distance from a physical object. After these adjustments are completed, the image returns to an image IM30 and performance information set in a detailed setting process is transmitted to the mobile object management server 100 by selecting the icon IC31 and a performance is executed in set content. When the icon IC33 has been selected, even if the user participates in the parade itself, a standard performance operation is not performed and only a simple performance such as tracking the parade is executed. Thereby, the user U can participate in the parade with a performance corresponding to his or her own preferences and mood at that time, and can enjoy the event more. The above-described adjustment information for the performance operation may be sent by the terminal device 200 to the mobile object management server 100, and the new adjusted event operation instruction may be acquired and transmitted to the ridable mobile object 300, or the terminal device 200 may directly adjust parameters and the like of the event operation instruction obtained from the mobile object management server 100 and transmit the adjusted parameters and the like to the ridable mobile object 300.

The mobile object management server 100 may refer to the user information 181 and make an adjustment such as a process of making the rotational speed at the time of turning when the user U on board is a child (for example, 12 years old or younger) lower than that when the user U is an adult and cancelling the settings of the user U. Thereby, a safer operation can be executed for each user U. Therefore, even if the user U is a child, a parent can allow the child to use the ridable mobile object 300 or participate in the event safely.

Referring back to FIG. 12, the mobile object management server 100 generates an event operation instruction for causing the ridable mobile object 300 to execute operation content corresponding to the selected possible participation level (step S124) and transmits the generated operation instruction to the terminal device 200 (step S126).

The terminal device 200 transmits an operation instruction transmitted from the mobile object management server 100 to the ridable mobile object 300 (step S128). The ridable mobile object 300 executes an operation mode and an output mode on the basis of the event operation instruction obtained from the terminal device 200 (step S130). Execution results are transmitted to the terminal device 200 (step S132). The terminal device 200 transmits the execution results transmitted from the ridable mobile object 300 to the mobile object management server 100 (step S134).

The mobile object management server 100 updates a usage state such as the number of uses and the usage time of the ridable mobile object 300 included in the usage history information 183 for each user (step S136). Subsequently, the mobile object management server 100 rents the ridable mobile object 300 or provides incentives corresponding to a rental fee, an event participation fee, or the like to the service provider who planned the event (step S138). The mobile object management server 100 may provide incentives to a user who participated in the event. Thereby, the process of this sequence ends. According to the above-described process, the mobile object management server 100 can manage the participation of the user U in the event and can provide an event with a higher performance effect.

### [Specific Examples of Services Provided by Mobile Object Management System]

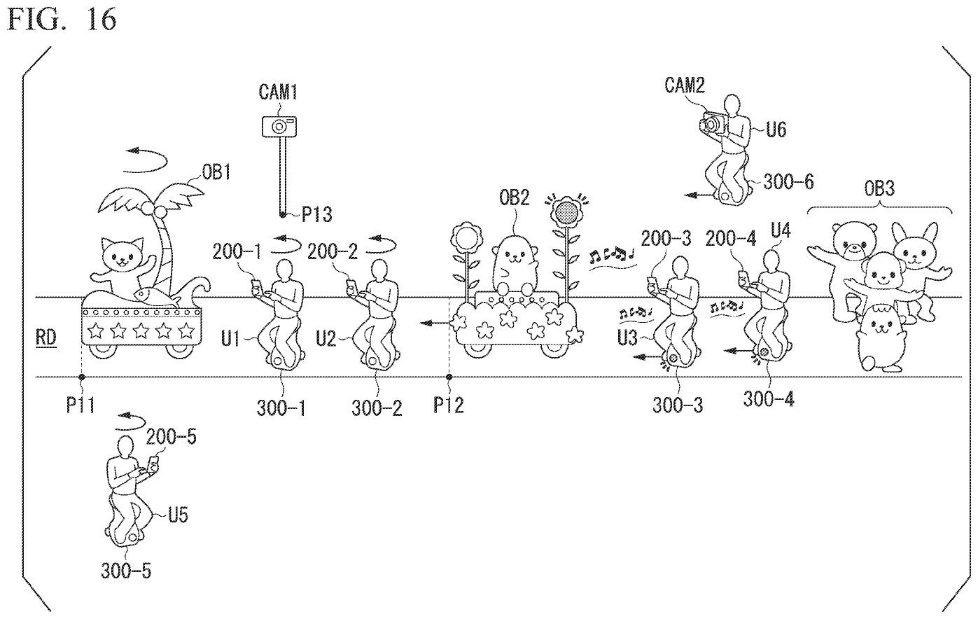

Hereinafter, specific examples of services provided by the mobile object management system 1 will be described. FIG. 16 is a diagram showing a specific example of mobile object management of the ridable mobile object 300. In the example of FIG. 16, a state of an event for parading on a road RD inside of a theme park is shown as an example of a service. In the example of FIG. 16, objects OB1 to OB3 and users U1 to U4 participate in the parade. The objects OB1 to OB3 are examples of objects related to the event. More specifically, the objects OB1 and OB2 are parade cars and the objects OB3 are one or more characters. The users U1 to U4 have terminal devices 200-1 to 200-4 corresponding thereto and are on ridable mobile objects 300-1 to 300-4. It is assumed that possible participation levels of the users U1 and U2 satisfy possible participation conditions for performing operations like a performance operation of the object OB1 and possible participation levels of the users U3 and U4 satisfy possible participation conditions for performing operations like a performance operation of the object OB2.

The manager 140 of the mobile object management server 100 manages which physical object passes through which point at what time and the operation mode and an output mode to be executed by each of the objects OB1 to OB3 on the basis of the event information 182. For example, the manager 140 performs a performance for rotation in a prescribed rotation direction when the object OB1 shown in FIG. 16 has reached a point P11 of the road RD and performs a performance for outputting music when the object OB2 has reached a point P12 of the road RD. In this case, the mobile object management server 100 performs operations or outputs based on operation modes or output modes of the objects OB1 and OB2 with respect to the ridable mobile objects 300-1 to 300-4 located near the objects OB1 and OB2 on the basis of the operation modes or the output modes of the objects OB1 and OB2.

In the example of FIG. 16, when the object OB1 in the parade rotates in a prescribed rotation direction at a timing when the object OB1 has reached the point P11 of the road RD, a performance in which the ridable mobile objects 300-1 and 300-2 are also rotated in the same rotation direction in cooperation with the movement thereof is performed. In the example of FIG. 16, when music is output at a timing when the object OB2 in the parade has reached the point P12 of the road RD, a performance in which music similar thereto is also output from the speaker 317 of each of the ridable mobile objects 300-3 and 300-4 is performed. In the example of FIG. 16, when light of a prescribed color is emitted at a timing when the object OB2 has reached the point P12 of the road RD, a performance in which the light emitters 316 of the ridable mobile objects 300-3 and 300-4 emit light of colors similar thereto may be performed. The mobile object management server 100 may cause the ridable mobile objects 300-3 and 300-4 located within a prescribed distance from the character of the object OB3 to cooperate with character operations (for example, rotation, forward movement, rearward movement, and stopping). Thereby, it is possible for users to experience a performance with a sense of unity with the parade.

When there is a ridable mobile object 300 that a user who is not participating in the parade is on within a prescribed distance from the objects OB1 to OB3, the mobile object management server 100 may cause the ridable mobile object 300 to perform a performance operation corresponding to the motion of each of the objects OB1 to OB3 even if the user is not participating in the parade. In the example of FIG. 16, an example in which the ridable mobile object 300-5 that the user U5 who is not participating in the event is on rotates in accordance with the rotation operation of the object OB1 is shown. Thereby, any users who could not participate due to the limited number of people or the like can experience a performance with a sense of unity with the parade.

When a fixed camera CAM1 for photographing an event participant is provided at a prescribed location (a point P13 in FIG. 16) of a route along which the parade is performed, the mobile object management server 100 may control the operation of the ridable mobile object 300 so that the ridable mobile object 300 stops in front of the fixed camera CAM1 for a prescribed time. The fixed camera CAM1 is a digital camera that uses a solid-state image sensor such as, for example, a charge-coupled device (CCD) or a complementary metal oxide semiconductor (CMOS). Thereby, it is possible to reliably capture images (still images and moving images) of users having participated in the parade and it is possible to provide a higher value-added service by providing the captured images to users.

When a first user (for example, a child) who participates in the parade and a second user (for example, a parent) who photographs the user with a camera are managed in association, the mobile object management server 100 may perform an operation control process in which the ridable mobile object 300 of the first user is stopped in front of the ridable mobile object of the second user or the ridable mobile object 300 of the second user tracks the ridable mobile object 300 of the first user on the basis of location information of the ridable mobile objects 300 that the first and second users are on. In the example of FIG. 16, the ridable mobile object 300-3 of the user U3 and the ridable mobile object 300-6 of the user U6 are associated and the ridable mobile object 300-6 performs a tracking process at prescribed intervals from the ridable mobile object 300-3. Thereby, the user U6 can continue to photograph the state of the participation of the user U3 in the event with the camera CAM2 while tracking the user U3.

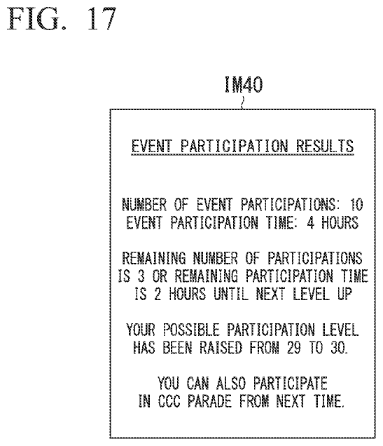

The mobile object management server 100 may provide information about a participation result to the user U who participated in the event after the event ends. FIG. 17 is a diagram showing an example of an image IM40 provided to the user U who participated in the event. The image IM40 shown in FIG. 17 includes, for example, the number of times the user U participates in an event (an example of the number of uses) and participation time (an example of usage time), the remaining number of participations or participation time until the next level up, information about the level of the user U, event information corresponding to the level, and the like. The image IM40 may include information related to a performance operation (for example, rotation, cooperation with another user, or the like) capable of being executed by performing a level-up process.

The manager 140 generates the image IM40 including the above-described information, and transmits the generated image IM40 to the terminal device 200 of the target user U via the network NW. The terminal device 200 receives the image IM40 and causes the output 230 to display the image IM40. The mobile object management server 100 may transmit information for generating the image IM40 to the terminal device 200 of the target user, generate the image IM40 on the terminal device 200 side, and cause the output 230 to output the image IM40. Thus, it is possible to allow the user U to clearly ascertain a participation state (a usage state of the ridable mobile object 300) and further improve the motivation to participate (the motivation to use) by providing the image IM40 to the user U.

### Modified Examples

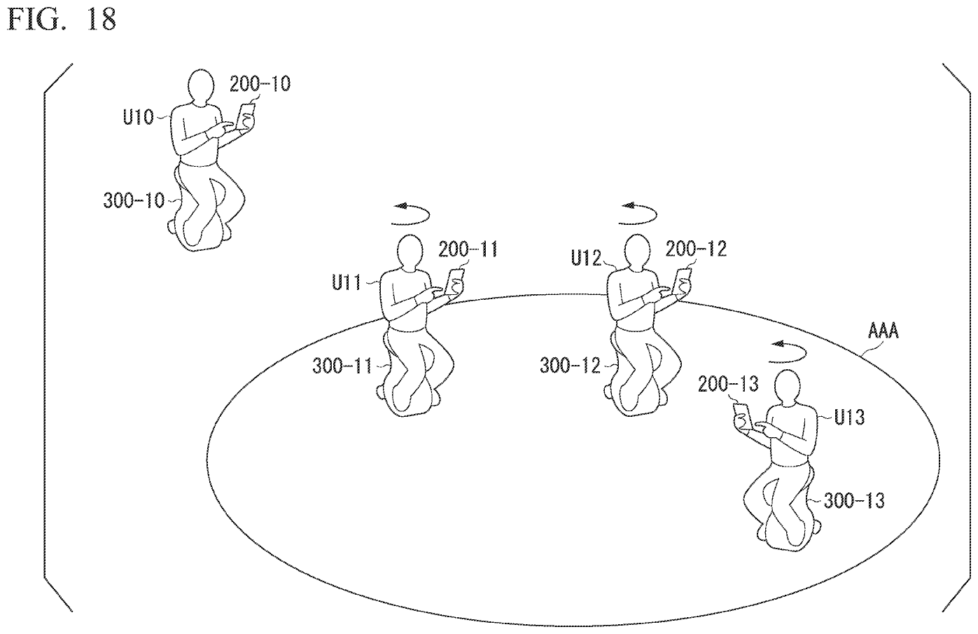

For example, in a service provided by the mobile object management system 1 of the embodiment, a lecture about a performance operation of the ridable mobile object may be given in advance to the user U scheduled to participate in an event and the user U may be permitted to participate in the event after the lecture. FIG. 18 is a diagram for describing a state in which a lecture about a performance operation is given to the user U scheduled to participate in an event. In the example of FIG. 18, an instructor U10 is a person who gives a lecture about the performance operation of the ridable mobile object 300 at the time of the event and users U1 to U13 are persons scheduled to participate in an event for receiving the lecture. The participation manager 143 of the mobile object management server 100 asks the terminal devices 200-11 to 200-13 of the users U11 to U13, which have received information indicating participation in the event, about whether or not the users U11 to U13 will receive the lecture, and provides a notification of an area (location) AAA where the lecture will be given and a meeting time if an instruction indicating that they will receive a lecture has been received. The participation manager 143 notifies the terminal device 200-10 of the instructor U10 that has been predetermined of information about a location where a lecture will be given, a meeting time, and content of the lecture.

The instructor U10 gives a lecture to the users U1 to U13 who gathered in the area AAA at the meeting time about the operation of the ridable mobile object 300 (for example, rotation, forward movement, rearward movement, or the like) and the operations of the users U1 to U13 (for example, waving, looking up, clapping, holding hands with other users nearby, and the like) to be executed during the event. In this case, the participation manager 143 generates information about a performance operation at the time of event execution by the event operation instructor 160, transmits the generated information to the terminal device 200-10 of the instructor U10, and causes a sample operation by the ridable mobile object 300-10 of the instructor U10 to be executed. The participation manager 143 transmits information about performance operations of the ridable mobile objects 300-11 to 300-13 to the terminal devices 200-11 to 200-13 of the users U11 to U13 and causes the ridable mobile objects 300-11 to 300-13 to execute the performance operations in the event.

The participation manager 143 may be configured to be able to notify the terminal devices 200-11 to 200-13 of the users U11 to U13 of a moving image when the event scheduled for participation is executed in the past and display the moving image from the output 230. Thereby, each of the users U11 to U13 can more accurately ascertain what type of motion they will perform by watching the moving image.

After the lecture from the instructor U10 is completed, the terminal devices 200-11 to 200-13 of the users U11 to U13 are asked again about whether or not to participate in the event and the participation manager 143 permits the user to participate in the event when information indicating that the user participates in the event has been received. In place of the terminal devices 200-11 to 200-13 of the users, the terminal device 200-10 of the instructor U10 may be asked about whether or not the users U11 to U13 may participate in the event and the event participation of the user determined to be able to participate in the event from a viewpoint of the instructor U10 may be permitted. Thereby, users can participate in the event more safely.

By gathering users who plan to participate in the event in the same place and giving lectures, the burden on the instructor can be reduced and a sense of camaraderie can be strengthened because users can compare operations and teach each other. Therefore, a plurality of users can perform a performance in a group more enjoyably.

In the embodiment, instead of deciding on a level at which the user U can participate in the event in accordance with a usage state of the ridable mobile object 300 of the user U, the participation manager 143 may make an adjustment for temporarily increasing the possible participation level of the user U, for example, when specific conditions related to a date and time such as a period when there is an event such as a birthday for the user U or a certain event such as Christmas are satisfied. Thereby, because the user can experience a special performance on a special day, the performance effect can be further improved.

Although the ridable mobile object 300 is allowed to execute operations and outputs in accordance with the execution of the event in the above-described embodiment, the operation and output may also be controlled in accordance with the execution of the event from the terminal device 200 in addition thereto. In this case, for example, the mobile object management server 100 generates an event operation instruction for operating a vibration function provided inside of the terminal device 200 in accordance with the event, outputting a prescribed sound from a speaker, or causing a display or the like to emit light and transmits the generated event operation instruction to the terminal device 200. In this way, it is possible to further improve the performance effect on the user U by operating various devices in accordance with the event.

In the embodiment, when the ridable mobile object 300 includes a location acquirer instead of using the location information of the terminal device 200, the mobile object management server 100 may communicate directly with the ridable mobile object 300 without involving the terminal device 200.

According to the above-described embodiment, the mobile object management server (mobile object management device) 100 for managing the ridable mobile object 300 that the user U gets on and which moves inside of a prescribed area includes the acquirer 130 configured to acquire location information of the ridable mobile object 300; the manager 140 configured to manage the ridable mobile object 300 and the terminal device 200 of the user U on the ridable mobile object 300 in association with each other; and the event operation instructor 160 configured to cause the ridable mobile object 300 to execute a prescribed operation corresponding to an event via the terminal device 200 of the user U on the basis of the location information and information about the event that is executed inside of the prescribed area, wherein the manager 140 manages whether or not to permit participation in the event of the user U on the basis of a state in which the user U uses the ridable mobile object 300, whereby it is possible to perform the event participation type performance and further improve the event performance effect.

According to the embodiment, by allowing the user to participate in the event, it is possible to further entertain users who like events such as parades and fans of dancers and characters participating in the event. According to the embodiment, by changing an operation capable of being executed by the ridable mobile object 300 in accordance with the user's possible participation level, for example, various performance operations such as an operation in which a performance in which only the light emitter 316 of the ridable mobile object 300 initially emits light can be operated in accordance with a sound and operations that are performed like those of the character can be experienced.

The embodiment described above can be represented as follows.

A mobile object management device including:

a storage medium storing instructions capable of being read by a computer of the mobile object management device for managing a ridable mobile object that a user is allowed to get on and which moves inside of a prescribed area; and

a processor connected to the storage medium,

wherein the processor executes the instructions capable of being read by the computer to:

acquire location information of the ridable mobile object;

manage the ridable mobile object and a terminal device of the user on the ridable mobile object in association with each other;

cause the ridable mobile object to execute a prescribed operation corresponding to an event via the terminal device of the user on the basis of the location information and information about the event that is executed inside of the prescribed area; and

manage whether or not to permit participation in the event of the user on the basis of a state in which the user uses the ridable mobile object.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A mobile object management device for managing a ridable mobile object that a user is allowed to get on and which moves inside of a prescribed area, the mobile object management device comprising:
an acquirer configured to acquire location information of the ridable mobile object;
a manager configured to manage the ridable mobile object and a terminal device of the user on the ridable mobile object in association with each other; and
an event operation instructor configured to cause the ridable mobile object to execute a prescribed operation corresponding to an event via the terminal device of the user on the basis of the location information and information about the event that is executed inside of the prescribed area,
wherein the manager manages whether or not to permit participation in the event of the user on the basis of a state in which the user uses the ridable mobile object.

2. The mobile object management device according to claim 1, wherein the manager decides on an event in which the user is able to participate on the basis of information including at least one of the number of uses and usage time of the ridable mobile object of the user.

3. The mobile object management device according to claim 1, wherein the manager sets a possible participation level of the user for the event on the basis of a state in which the user uses the ridable mobile object and manages an operation capable of being executed by the ridable mobile object of the user in accordance with the set possible participation level.

4. The mobile object management device according to claim 3, wherein the manager manages a performance operation of the event in which the user is able to participate on the basis of the possible participation level.

5. The mobile object management device according to claim 3, wherein the manager acquires an event in which the user is able to participate on the basis of the possible participation level and notifies the user of information for asking the user about whether or not to participate in the acquired event.

6. The mobile object management device according to claim 1, wherein the manager restricts participation in an event in which the user was able to participate in the past on the basis of at least one of elapsed time after the user previously participated in the event and elapsed time after the user previously rode the ridable mobile object.

7. The mobile object management device according to claim 1, wherein the manager transmits information for giving a lecture about an operation of the ridable mobile object to the user before the user participates in the event to a terminal device of the user.

8. The mobile object management device according to claim 1, wherein the manager provides the ridable mobile object to the user or gives incentives to a service provider that plans the event on the basis of the state in which the user uses the ridable mobile object.

9. The mobile object management device according to claim 1, wherein the event operation instructor adjusts content of the prescribed operation on the basis of information about the user on the ridable mobile object or a surrounding environment of the ridable mobile object.

10. The mobile object management device according to claim 1, wherein the event operation instructor adjusts content of the prescribed operation on the basis of setting content from the user on the ridable mobile object.

11. A mobile object management method comprising:
acquiring, by a computer of a mobile object management device for managing a ridable mobile object that a user is allowed to get on and which moves inside of a prescribed area, location information of the ridable mobile object;
managing, by the computer, the ridable mobile object and a terminal device of the user on the ridable mobile object in association with each other;
causing, by the computer, the ridable mobile object to execute a prescribed operation corresponding to an event via the terminal device of the user on the basis of the location information and information about the event that is executed inside of the prescribed area; and
managing, by the computer, whether or not to permit participation in the event of the user on the basis of a state in which the user uses the ridable mobile object.

12. A computer-readable non-transitory storage medium storing a program for causing a computer of a mobile object management device for managing a ridable mobile object that a user is allowed to get on and which moves inside of a prescribed area to:
acquire location information of the ridable mobile object;
manage the ridable mobile object and a terminal device of the user on the ridable mobile object in association with each other;
cause the ridable mobile object to execute a prescribed operation corresponding to an event via the terminal device of the user on the basis of the location information and information about the event that is executed inside of the prescribed area; and
manage whether or not to permit participation in the event of the user on the basis of a state in which the user uses the ridable mobile object.
